(19) United States
(12) Patent Application Publication
(10) Pub. No.: US 2021/0019833 A1
(43) Pub. Date: Jan. 21, 2021

(54) System and Method for Rule Set Selection

(71) Applicant: Bdellium, Inc., Ageo City (JP)

(72) Inventors: Richard Christopher Dunne, Ageo City (JP); Thomas Richard Kmak, Scottsdale, AZ (US)

(73) Assignee: Bdellium, Inc., Ageo City (JP)

(21) Appl. No.: 17/064,209

(22) Filed: Oct. 6, 2020

Related U.S. Application Data
(63) Continuation of application No. 13/844,316, filed on Mar. 15, 2013, now abandoned.
(60) Provisional application No. 61/675,482, filed on Jul. 25, 2012.

(51) Int. Cl. G06Q 40/06; G06Q 40/08

(52) U.S. Cl. CPC G06Q 40/06; G06Q 40/08

(57) ABSTRACT

A method is disclosed including receiving data relating to the determination of an optimal plan design, and storing the received data in memory on at least one computer; formulating, as optimization questions, a plurality of questions related to determination of an optimal plan design; storing the optimization questions in memory on at least one computer; delivering the optimization questions to a plurality of respondents; receiving, as optimization responses, responses to the optimization questions; creating, as optimization rules, a plurality of rules for using received data and optimization responses to determine an optimized plan design; storing the optimization rules in memory in at least one computer, and performing in a computer an optimization process that applies the optimization rules to the received data and optimization responses in order to determine an optimized plan design.

### CROSS-REFERENCE TO RELATED CASES

This application is a continuation of U.S. application Ser. No. 13/844,316, filed on Mar. 15, 2013 (the '316 application). The '316 application claims the benefit of Provisional U.S. Application No. 61/675,482, filed on Jul. 25, 2012. All of these related cases are expressly incorporated herein by reference in their entireties.

### TECHNICAL FIELD

The technical field relates in general to defined contribution plans, and in particular, methods and system for designing defined contribution plans.

### BACKGROUND

The 2012 Census Bureau Statistical Abstract shows that more than 70 million U.S. residents will reach retirement age within the next two decades. Driven primarily by a wave of aging “Baby Boomers”, this massive demographic shift will profoundly impact American society. Unfortunately, many of these 70 million U.S. residents are not adequately prepared to fund their retirement years.

The 2012 Retirement Confidence Survey conducted by the Employee Benefit Research Institute (EBRI) found that more than half (56 percent) report that they and/or their spouse have not tried to calculate how much money they will need to have saved by the time they retire so that they can live comfortably in retirement. Not surprisingly, the same survey found that just 14 percent are very confident they will have enough money to live comfortably in retirement.

Traditionally, Social Security, employer-provided benefits and personal savings have constituted the “three-legged stool” of retirement security. As the long-run actuarial deficits of the Social Security program continued to worsen in 2012, the Trustees of the Social Security and Medicare trust funds warned that lawmakers should be aware that it will become increasingly difficult to avoid adverse effects on current beneficiaries, those close to retirement and low-income beneficiaries in all age cohorts if legislative changes are delayed much longer. With uncertainty about future funding, many observers expect a reduction in the portion of future retirement income that will be provided through Social Security benefits.

In December 2006 the National Bureau of Economic Research published a paper in which the authors noted that over the previous two and a half decades there had been a rapid shift from saving through employer-managed Defined Benefit (DB) pensions to Defined Contribution (DC) retirement savings plans that are largely controlled by employees. Research by TowersWatson shows that between 1998 and 2011 the number of Fortune 100 companies that offered only a DC plan to newly-hired employees rose from just 10 to 70 companies. According to the Investment Company Institute, at the end of the first quarter of 2012, out of US$18.9 trillion in total retirement assets, US$10 trillion or 53% is held in Individual Retirement Accounts (IRAs) and DC plans, compared to only US$7.2 trillion or 38% in private DB plans or government plans.

While more assets are now held in IRAs (US$5.2 trillion) than in DC plans (US$4.8 trillion), the majority of IRA inflows are rollovers from employer-sponsored DC plans. This is despite evidence that a significant percentage of workers who terminate employment take a cash distribution, thereby eroding private retirement savings. For example, among workers who terminated from employment in 2010, 42% took a cash distribution, which is consistent with pre downturn levels and only 29% rolled assets over to a qualified plan.

As a result of this increasing reliance on DC plans, three of the most important leading indicators of whether an employee is on track to retire securely are participation or non-participation in their employer-sponsored DC plan, the percentage of annual earnings that the employee is contributing to their retirement account and the percentage of annual earnings that the employer contributes to the employee's retirement account.

The enactment by Congress of the 2006 Pension Protection Act (PPA) represented the most significant change to pension funding legislation since the Employee Retirement Income Security Act (ERISA) of 1974. While the PPA was primarily viewed as an attempt to reinforce the DB pension system, the new law also provided sponsors of DC plans with protections and support to increase worker participation and total savings. Subject to satisfying certain procedural requirements, the PPA grants plan sponsors safe harbor immunity from fiduciary liability related to the automatic enrollment of workers in DC plans, automatic deferral of an increasing portion of workers' earnings as contributions to their DC plan retirement account and automatic investment of a participant's retirement account assets in what is called a Qualified Default Investment Alternative (QDIA). The PPA makes it easier for employers to compel workers to start saving for retirement with the hope that, while the law permits any worker to opt out, inertia will ensure that many continue to save, thereby improving the retirement readiness of the overall population.

Data from the Plan Sponsor Council of America (PSCA) Annual Survey of 401(k) and profit sharing plans indicates that in 2005, one year prior to the PPA, only 16.9% of all plans in their survey used auto-enrollment and only 77.5% of workers who qualified to participate in their employer-sponsored DC plan were doing so. By 2008, 39.6% of respondent plans were using auto-enrollment and the average participation rate was 82.7%. The latest available PSCA data, for the 2010 plan year, shows 41.8% of respondent plans using auto-enrollment and 86.3% of eligible employees with account balances.

While the PSCA survey data seems to indicate a positive correlation between use of automatic enrollment and higher employer participant rates, 58.2% of respondents for the 2010 plan year (particularly plans with fewer than 50 members) still did not use this feature, and almost 24% of eligible employees are still not participating in their employer-sponsored plans. Furthermore, analysis by the Bureau of Labor Statistics of 2009 National Compensation Survey (NCS) data shows that only 19% of all workers were in savings and thrift plans with automatic enrollment features.

In order for a 25 year old worker to achieve a secure retirement at age 67, without taking excessive investment risk, their total savings rate (which equals participant deferrals plus employer contributions) should be at least 15% of their earnings each year. The total savings rate required by older workers depends on how much they have saved in previous years and whether they have earned a positive return or incurred losses on the investment of retirement assets.

The NCS data cited above shows that the median default deferral rate for participants who are automatically enrolled in DC plans is 3% of annual earnings. However, a 2012 survey by Lincoln Financial Group reported that plans with automatic escalation experienced deferral rates of 8.3% or higher. This compares to average deferral rates of 4% or less for the majority of plans in America. Furthermore, as reported by TowersWatson in January 2011, “auto-escalation is correlated with a lower opt-out rate.” Nonetheless, 42% of plan sponsors that offer auto-enrollment do not offer contribution escalation.

The employer contribution usually consists of some basic contribution for all eligible employees (expressed either as a dollar amount or a fixed percentage of annual earnings) plus a matching contribution that is linked via a standard formula to the employee's own deferral. That matching formula, in turn, specifies what percentage of the participant's deferral rate the employer will contribute and the maximum participant deferral rate to which the match will apply, e.g., matching 25% up to a maximum matched participant deferral rate of 8%. Sometimes the match formula will include two tiers with different match rates. For example, an employer might match 25% up to a participant deferral rate of 6% and 50% on any participant deferral rate between 6% and 10%.

NCS data for 2009 reported a very high variance in the maximum potential employer contribution for workers in plans that specify a matching contribution, ranging from 1.5% at the 10th percentile to 6.0% at the 90th percentile. Furthermore, the total amount an employer actually contributes to any particular participant depends both on the matching formula and on the level of the participant's own deferrals. Unfortunately, despite encouragement from their employers, many participants fail to save enough to maximize their employer contribution. This means that while the previously-cited PSCA data shows that employer contributions have averaged between 4% and 5% of annual earnings from 2004 through 2010, in many cases a portion of the employer's available budget remained unclaimed every year. An NBER working paper published in July 2012 considered the impact of the matching formula on employee savings. Specifically, the author suggests that providing a lower match rate up to a higher maximum matched participant deferral (for example, matching 25% of a participant's deferral up to a maximum deferral rate of 10%) might generate higher employee savings than combining a higher match rate with a lower ceiling (such as matching 50% up to a maximum deferral rate of 5%).

The employer match is often one of the earliest victims of economic recession. Between October 2008 and May 2009, at least 170 employers announced plans to suspend or reduce employer matching contributions as a cost-cutting response to difficult economic conditions. This meant that participants who would have already experienced a decline in the value of their retirement savings due to investment losses suffered a second blow of also losing their employer's contribution. Even though some employers reinstated their matching contributions one year later, the speed of restoration was slower than expected and also slower than in previous economic downturns. Just as employer contributions make both a direct and indirect contribution to total savings, their suspension, even for a short period, can have a serious negative effect on the saving habits of employees.

Available evidence suggests that both participation rates and participant deferrals increase as a result of implementing automated features in DC plans. However, as noted above, only a minority of plans offer the full combination of automatic enrollment and automatic escalation of deferrals. In addition, evidence suggests that both the provision and take-up of employer contributions is suboptimal in terms of maximizing total savings. Therefore, in order to significantly improve the retirement security of American workers, more plan sponsors need to implement plan design features such as automatic enrollment, automatic escalation of participant deferral rates and employer contribution formulae that increase both participation rates and total retirement savings.

One of the greatest challenges faced by plan sponsors is trying to decide what default participant deferral levels and employer contribution formula or formulae to implement within a plan design. For example, if the automatic deferral levels are set too high a greater proportion of participants will opt out altogether and defeat the purpose of increasing personal savings. Ideally the employer contribution formula would result in the full available budget being used but never exceeded. Setting a higher basic contribution benefits all employees and makes it easier for employers to forecast actual costs but leaves less of the total budget available for a matching contribution to encourage higher participant deferrals. Also, if considering any suspension or reduction in their matching contribution, it is essential that employers balance short-term cost savings against the longer-term impact on their employees' retirement security.

One way to help plan sponsors select the most effective plan design features is to provide detailed analysis of the current saving profile of individual participants, their current retirement readiness and the likely impact on that readiness and on employer budgets of changing different plan design provisions. The insights that plan sponsors can gain from such analysis should enable them to optimize their plan design taking account of each participant's retirement savings goal, participants' capacity to contribute to their retirement savings and the available employer contribution budget.

Today some pension consulting firms provide plan sponsors with a participant-level “gap analysis.” This typically measures the additional total savings, higher investment rate of return, number of working years or reduction in retirement income that each participant would need in order to achieve a secure retirement. A number of organizations also offer free online calculators to help individuals estimate how much of their estimated required retirement income they might be able to fund based on their current earnings and savings profile and these calculators sometimes also include a gap analysis. One critical limitation in the current state of the art is that simply aggregating individual gap analysis does not enable plan sponsors to sufficiently understand the relationships among plan design features, the cost to participants and sponsors of different plan designs and their impact on the retirement readiness of participants. Furthermore, while larger consulting firms do provide more sophisticated plan design analysis, these services tend to be very labor intensive and therefore prohibitively expensive for all but a small minority of larger plans. A further challenge is how best to display and report the results of an analysis to effectively communicate the most important relationships among prospective plan designs, cost and benefits.

### SUMMARY

Accordingly, one embodiment discloses herein provides a method of evaluating, using a computer coupled to a database, a plurality of plan design parameters governing operation of a selected retirement plan. The computer is programmed to perform the method, which comprises several steps.

The method initially comprises receiving data related to future retirement income needs from a plurality of individuals participating in the selected retirement plan. The method further comprises storing the received data. The method further comprises calculating, for each eligible participant in the plurality of eligible participants, a target retirement expenditure that is an amount of money a respective eligible participant desires to be able to spend during a specified retirement period. The method also comprises calculating, for each eligible participant in the plurality of eligible participants, a fundable retirement expenditure that is an amount of money a respective eligible participant can actually afford to spend during the same specified retirement period.

The method further comprises calculating, for each eligible participant in the plurality of eligible participants, a retirement security assessment that is a measurement of a relationship between a respective eligible participant's fundable retirement expenditure and the respective eligible participant's target retirement expenditure. The method also comprises calculating for each of the plurality plan design parameters, and for each eligible participant in the plurality of eligible participants, an impact analysis that is an effect on a respective eligible participant's fundable retirement expenditure of a respective plan design parameter, thereby creating a set of impact analyses for each plan design parameter. The method further comprises analyzing the set of impact analyses for a plurality of plan design parameters, and creating an analysis result for each respective set of impact analyses as a plan design analysis.

A second embodiment disclosed herein provides a method of determining, as an optimized plan design, a plurality of rules to be used to govern operation of a selected retirement plan. The method requires the use of a computer coupled to a database of input data. The computer is programmed to perform the method steps.

The method comprises receiving data relating to the determination of an optimal plan design, and storing the received data in memory on at least one computer. The method further comprises formulating, as optimization questions, a plurality of questions related to determination of an optimal plan design. The method also comprises storing the optimization questions in memory on at least one computer.

The method further comprises delivering the optimization questions to a plurality of respondents. The method also comprises receiving, as optimization responses, responses to the optimization questions. The method further comprises creating, as optimization rules, a plurality of rules for using received data and optimization responses to determine an optimized plan design. The method also includes storing the optimization rules in memory in at least one computer, and performing in a computer an optimization process that applies the optimization rules to the received data and optimization responses in order to determine an optimized plan design.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 illustrates a system 100 for evaluating a plurality of plan design parameters governing operation of a selected retirement plan and for also optimizing a plan design.

FIG. 2 illustrates a system 200 for extracting input data, generating individual analysis results data, and generating aggregated analysis results data.

### DETAILED DESCRIPTION

In order to address limitations in the current state of the art, a system and method is disclosed that integrates individual gap analysis with plan design optimization in a scalable manner that makes the service economically viable for even the smallest plan sponsor or individual participant. A further benefit of the disclosed system and method is that it can identify and encourage plan sponsors to implement plan design features that are proven to increase workers' retirement security by quantifying additional benefits that can be achieved for their specific workforce, without exceeding their available budget.

The instant disclosure is thus provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such software and ICs, if any, will be limited to the essentials with respect to the principles and concepts used by the exemplary embodiments.

Some definitions are now provided. In this disclosure, “Auto-Enrollment” may indicate a Plan Design provision that requires all eligible Participants to be automatically enrolled in a Plan and sets a minimum automatic Participant Deferral or Participant Deferral Rate.

In this disclosure, “Auto-Escalation” may indicate a Plan Design provision under which a Participant Deferral Rate automatically increases periodically (usually annually) by a pre-determined percentage of annual earnings.

In this disclosure, “Auto-Escalation Maximum Deferral Rate” may indicate a Participant Deferral Rate at which Auto-Escalation ceases to apply to a particular Participant. Any Participant may voluntarily contribute at a rate higher than an Auto-Escalation Maximum Deferral Rate, but no Participant is required to do so.

In this disclosure, “Auto-Escalation Rate” may indicate a percentage of earnings by which a Participant Deferral Rate is automatically increased periodically under Auto-Escalation.

In this disclosure, “Catch-up” may indicate a plan design provision that permits (but does not require) a Participant aged 50 years or more to make additional tax-favored contributions to a Plan, subject to limits set under applicable IRS regulations.

In this disclosure, “Employer Basic Contribution” may indicate a dollar amount or percentage of Participant earnings that an employer contributes to each Participant's Plan account irrespective of the level of Participant Deferral.

In this disclosure, “Employer Matching Contribution” may indicate a dollar amount that an employer contributes to each Participant's Plan account based on a related Participant Deferral level.

In this disclosure, “Employer Matching Contribution Limit” may indicate either a maximum Participant Deferral amount or a maximum Participant Deferral Rate to be multiplied by an Employer Matching Contribution Rate in determining an Employer Matching Contribution.

In this disclosure, “Employer Matching Contribution Rate” may indicate a percentage by which a Participant Deferral Rate is multiplied to determine an Employer Matching Contribution.

In this disclosure, “Employer Total Contribution” may indicate the sum of a Basic Employer Contribution and an Employer Matching Contribution.

In this disclosure, “ERISA” may indicate the Employee Retirement Income Security Act of 1974, and related rules and regulations, as amended from time to time.

In this disclosure, “Participant” may indicate a member or beneficiary of a Plan.

In this disclosure, “Participant Deferral” may indicate a dollar amount that a Participant contributes to a Plan.

In this disclosure, “Participant Deferral Rate” may indicate a percentage of annual earnings that a Participant contributes to a Plan.

In this disclosure, “Plan” may indicate any Defined Contribution Plan, including 401(k), 403(b), 457, profit sharing or money purchase plan.

In this disclosure, “Plan Design” may indicate a set of provisions governing operation of a Plan, including but not limited to, Auto-Enrollment, Auto-Escalation, Auto-Escalation Maximum Deferral Rate, Employer Basic Contribution, Employer Matching Contribution Rate, Maximum Matched Participant Deferral Rate.

In this disclosure, “Plan Sponsor” may indicate an employer or party offering a Plan to a Participant.

In this disclosure, “Qualified Default Investment Alternative” and “QDIA” may indicate an investment into which a Plan Sponsor may invest a Participant's savings in a Plan and enjoy certain safe harbor protections from fiduciary liability, provided that all requirements of applicable regulations are satisfied.

In this disclosure, “Required Retirement Income” may indicate an amount of post-retirement pre-tax income that a Participant is expected to need to fund a Secure Retirement.

In this disclosure, “Retirement Readiness Ratio” may indicate a percentage of Required Retirement Income that a participant is projected to be able to fund from all funding sources.

In this disclosure, “Savings Accounts” may indicate a Plan account, an Individual Retirement Account, a brokerage account, a bank account, a loan account and any similar financial account or any subset thereof.

In this disclosure, “Secure Retirement” may indicate an accumulation of sufficient capital by a target retirement age to be able to buy a guaranteed, lifetime, inflation-protected retirement income payment that, in combination with Social Security and any employer-provided benefits, allows a person to maintain a desired standard of living. In each case, use of “Secure Retirement” as a prefix in combination with another defined term may indicate a level of the indicated parameter required to enable a Participant to achieve a Secure Retirement assuming that all other parameter assumptions remain unchanged.

In this disclosure, “Total Savings Balance” may indicate a total of balances in Savings Accounts.

In this disclosure, “Total Savings” may indicate a dollar amount of all contributions made to Savings Accounts within a specified period.

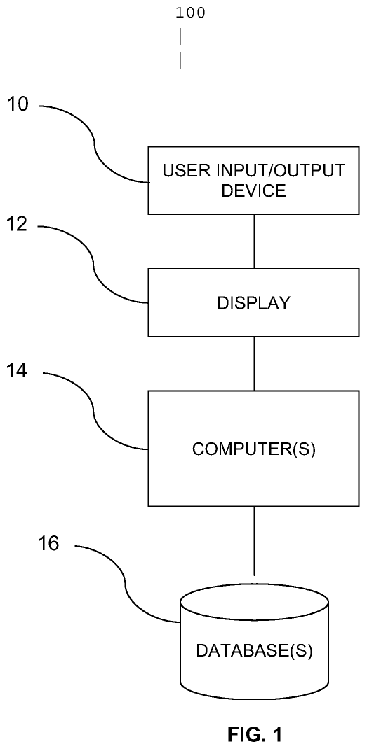

Referring now to FIG. 1, a system 100 for evaluating a plurality of plan design parameters governing operation of a selected retirement plan and for optimizing a plan design is discussed. The system 100 includes a user input/output device 10, a display 12, one or more computers 14, and one or more databases 16. The user input/output device 10 includes a display 12. The user input/output device 16 is connected to the one or more computers. The one or more computers 14 are connected to the one or more databases 16.

The user input/output device 10 can be a personal computer, a tablet device, a smart phone or any devise capable of connecting to the internet or to another computer. The user input/output device 10 connects to the one or more computers 14 through a wired connection, a wireless connection, a direct connection or an indirect connection over a local area network or a wide area network, or a virtual private network or the public internet. The one or more computers 14 may be configured to perform multiple tasks within a single machine or the one or more computers 14 may represent multiple connected machines, each performing one or more tasks.

The one or more databases 16 may be configured as a single database or as multiple connected databases for optimal performance. The data in the database can be stored locally, on portable media such as an external hard drive, flash drive, CD-ROM or DVD, or accessed over a local areas network, or a wide area network, or a virtual private network or the public internet. The one or more databases 16 may be of distributed nature with multiple physical storage sites

The user input/output device 10 is used to upload data to the one or more computer 14, which is then stored in the one or more databases 16. A user input/output device 10 may require manual data input or may make use of a separate software program to deliver data to the one or more computers 16 as a batch process or a real-time feed. Custom software programs installed on the one or more computer 16 execute the methods of the claimed invention and store the results in the one or more databases 16. Additional custom software programs deliver analysis results to a user through the input/output device 10.

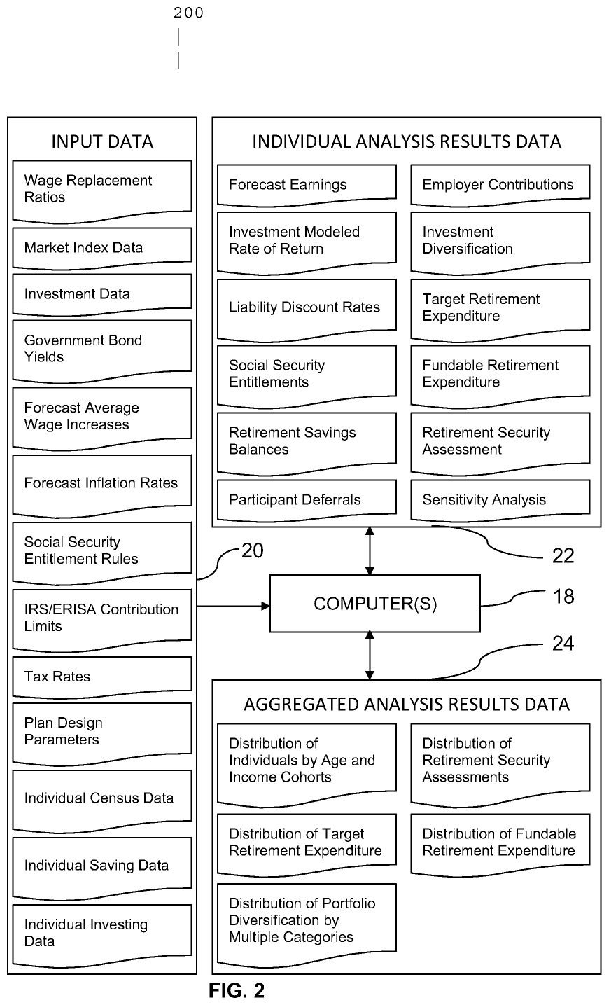

FIG. 2, which illustrates a system 200 for extracting input data, generating individual analysis results data, and generating aggregated analysis results data, is now discussed. The system 200 in FIG. 2 illustrates a first database 20, a second database 22, and a third database 24. The first, second, and third databases 20, 22, and 24 are connected to computers 18 that has custom software installed thereon. The computer 18 executes instructions that result in a first series of steps being performed that results in extracting input data from a first database 20. The input data includes information related to Wage Replacement Ratios, Market Index Data, Investment Data, Government Bond Yields, Forecast Average Wage Increases, Forecast Inflation Rates, Social Security Entitlement Rules, IRS/ERISA Contribution Limits, Tax Rates, Plan Design Parameters, Individual Census Data, Individual Saving Data, and Individual Investing Data.

The computer 18 then executes instructions that results in a second series of steps being performed that generate individual analysis results data that is stored in a second database 22. The generated individual analysis results data includes information related to Forecast Earnings, Investment Modeled Rate of Return, Liability Discount Rates, Social Security Entitlements, Participant Deferrals, Employer Contributions, Investment Diversification, Retirement Savings Balances, Target Retirement Expenditure, Fundable Retirement Expenditure, Retirement Security Assessment, and Sensitivity Analysis.

The computer 18 then executes instructions that results in a third series of steps being performed that generates aggregated analysis results data that is stored in a third data base 24. The aggregated analysis results data includes Distribution of Individuals by Age and Income Cohorts, Distribution of Retirement Security Assessments, Distribution of Target Retirement Expenditure, Distribution of Fundable Retirement Expenditure, and Distribution of Portfolio Diversification by Multiple Categories.

In FIG. 2 input data that is stored in database 20, and is used by computer 18 to execute the steps of the claimed methods disclosed herein, include general public data, public and private data related to plan design and private individual data. These data are gathered from multiple sources using the process illustrated in FIG. 1. The data stored in database 22 and database 24 are all generated as a result of the computer 18 being programmed to perform the steps of the claimed embodiments described and claimed herein.

Generally speaking, aggregated analysis results shown in database 24 cannot be generated until individual analysis results data are generated and stored in database 22. The specific data shown in FIG. 2 is illustrative only and is not an exhaustive list of all data that is or might be used in an embodiment of the present invention.

Other embodiments are disclosed herein. A computer system for evaluating Plan Design is disclosed that comprises a computer server having a database. The database stores a plurality of data that are representative of saving behavior and investing behavior characteristics of a plurality of Participants; rules governing Plan operation; a plurality of Plan investment options; and legal rules and regulations affecting Secure Retirement. A non-transitory computer-readable storage medium is encoded with a first computer program executable by a computer for analyzing a Retirement Readiness Ratio of a Participant using data in the database. A non-transitory computer-readable storage medium is encoded with a second computer program executable by the computer for determining an optimal Plan Design that reflects stored data in relation to Plan Design policies, objectives, preferences and constraints. A non-transitory computer-readable storage medium is encoded with a third computer program executable by the computer for analyzing interactive effects among Plan Design, Employer Total Contribution, Participant behavior and Retirement Readiness Ratio. A non-transitory computer-readable storage medium is encoded with a fourth computer program executable by the computer for permitting one or more of production, configuration, selection, and automatic generation of one or more reports, where a report may include a comparison of the effects of one or more specified changes in Plan Design on one or more of Participant saving behavior, Participant investing behavior, Participant Retirement Readiness Ratio, Employer Total Contribution and Plan investment options.

A method for evaluating Plan Design is disclosed. The method may include receiving a plurality of data that are representative of saving behavior and investing behavior characteristics of a plurality of Participants in a Plan; receiving a plurality of data that are representative of rules governing operation of a Plan; receiving a plurality of data representative of policies, objectives, preferences or constraints related to optimization of a Plan Design; receiving a plurality of data representative of characteristics related to a plurality of investments; and receiving a plurality of data representative of legal rules and regulations affecting Secure Retirement. The method may further include storing the data in memory on one or more web-accessible computers; completing one or more analysis of the stored data; storing results of an analysis in memory on one or more computers; one or more of producing, configuring, selecting, or automatically generating one or more reports for demonstrating or displaying results of an analysis. One or more methods are performed when one or more of the four computer programs that are encoded on one or more of the above non-transitory computer-readable storage mediums are executed.

The step of receiving a plurality of data may include one or more of manually entering said data in forms that are displayed by a computer on a monitor; manually uploading an electronic file to a computer using an interface displayed on a monitor; automatically transferring data from an originating computer to a receiving computer as a real-time feed; and automatically transferring data from an originating computer to a receiving computer as a batch process.

The plurality of data representative of saving behavior and investing behavior characteristics of a plurality of Participants in a Plan may include, in respect of a participant, one or more of an identification code, a date of birth, a date on which current employment commenced, a date on which most recent employment terminated, gender, marital status, amount and details of any entitlement to receive future retirement benefit payments from a current employer, entitlement to receive future retirement benefit payments from a previous employer, historical annual earnings, current annual earnings, current retirement savings balance in each retirement account of which Participant is a beneficiary, current percentage of annual earnings being contributed to each retirement account of which Participant is a beneficiary, amount of Catch-up payments, amount invested in each of a plurality of investments, use of automatic portfolio rebalancing, use of professional investment advice services and other related data, as needed, to complete a desired analysis.

The plurality of data representative of rules governing operation of a Plan may include, in respect of a Plan, rules regarding one or more of eligibility to participate, use of Auto-Enrollment for newly-hired employees, use of Auto-Enrollment for employees who are not newly-hired employees, a minimum Auto-Enrollment Participant Deferral Rate, an Auto-Escalation Rate, a Maximum Automatic Participant Deferral Rate, provision for Catch-up, annual Employer Total Contribution budget, Employer Basic Contribution, Employer Matching Contribution formula, rules for determining vesting of employer-provided benefits, policy regarding use of “safe harbor” protections under ERISA, a name for each of an investment option offered, an identification code for each of an investment option offered, use of a Qualified Default Investment Alternative, policy regarding default of newly-hired employees retirement savings into a Qualified Default Investment Alternative, policy regarding default of employees who are not newly-hired employees into a Qualified Default Investment Alternative, provision of an automatic portfolio rebalancing service, provision of a professional investment advice service, provision of a brokerage account, provision of a fund window service and other related data, as needed, to complete a desired analysis. The plurality of data representative of rules governing operation of a Plan also may include one or more of: current rules in respect of a Plan, prospective rules in respect of a Plan, a plurality of policy parameters in respect of a Plan and other related data, as needed, to complete a desired analysis.

The plurality of data representative of one or more policies, objectives, preferences or constraints related to optimization of a Plan Design may include indications of one or more of an Employer Total Contribution budget amount expressed in dollars, an Employer Total Contribution budget amount expressed as a percentage of Participant earnings, a desired “safe harbor” protection, a desired level of Employer Basic Contribution expressed as a dollar amount, a desired level of Employer Basic Contribution expressed as a percentage of Participant earnings, a desired level of aggressiveness in setting a minimum Participant Deferral Rate under an Auto-Enrollment provision, a desired speed at which Participant Deferral Rates might increase under an Auto-Escalation provision, a desired range of Auto-Escalation Maximum Deferral Rate, desired conditions under which a Participant might receive a maximum Employer Matching Contribution and other related data, as needed, to complete a desired analysis.

The plurality of data representative of a plurality of investments may include, in respect of an investment, one or more of a name, an identification code, a plurality of historical periodic rates of return, a plurality of simulated periodic rates of return, percentage of a current portfolio invested in each of a plurality of investment categories, percentage of a historical portfolio invested in each of a plurality of investment categories, classification of an investment by asset class, classification of an investment by strategy style and other related data, as needed, to complete a desired analysis.

The plurality of data representative of legal limits affecting Secure Retirement may include a plurality of money amounts and percentages specified by law that define a legally permitted maximum level of a Participant Deferral and an Employer Total Contribution, including a maximum annual earnings that may be used to calculate contributions in any Plan year (“401(a)(17) Limit”), a maximum permitted dollar amount of regular participant deferrals in any Plan year (“402(g) Limit”), a maximum permitted combined dollar amount of a Participant Deferral and an Employer Total Contribution in any Plan year (“415(c) Limit”), a maximum permitted combined percentage of earnings for a Participant Deferral and an Employer Total Contribution in any plan year (“404(a)(3) Limit”), a maximum dollar amount of Catch-up payment permitted in any Plan year and similar limits that may be implemented by regulators from time to time. The plurality of data defining legal limits affecting Secure Retirement also may include reference data and calculation procedures that define an individual's entitlement to one or more of Social Security, Medicare and Medicaid.

The step of completing an analysis of the stored data may include calculating projections for a Participant comprising one or more of periodic earnings, Participant Deferrals, Employer Total Contributions, earnings on investment of retirement savings, minimum Required Retirement Income, future Social Security benefit entitlements, future employer-provided retirement benefits, expected Total Savings Balance as of a desired retirement date, expected cost of a future annuity payment and a Total Savings Balance required as of a desired retirement date to fund a Secure Retirement and a Retirement Readiness Ratio.

The step of completing an analysis of the stored data may include calculating projections for a Participant comprising one or more of a Secure Retirement date, a Secure Retirement Total Savings Balance, a Secure Retirement Total Savings Rate, a Secure Retirement Employer Total Contribution and a Secure Retirement Required Retirement Income level.

The step of completing an analysis of the stored data may include determining, in respect of a Plan, a number and percentage of all Participants having one or more of a date of birth within a specified range of dates, a Total Savings Balance within a specified dollar range, a Total Savings Balance within a specified percentage range of annual earnings, a Plan account balance within a specified dollar range, a Total Savings Rate within a specified percentage range of annual earnings, a Participant Deferral Rate within a specified percentage range of annual earnings, an Employer Total Contribution within a specified percentage range of annual earnings and a Retirement Readiness Ratio within a specified percentage range. The step of completing an analysis of the stored data may also include determining, in respect of a Plan, a number and percentage of all Participants having one or more of a Secure Retirement date within a specified range of dates, a Secure Retirement Total Savings Balance within a specified dollar range, a Secure Retirement Total Savings Balance within a specified percentage range of annual earnings, a Secure Retirement Participant Deferral Rate within a specified percentage range of annual earnings and a Secure Retirement Employer Total Contribution within a specified percentage range of annual earnings.

The step of completing an analysis of the stored data may include determining optimal values of one of more Plan Design provisions, using as inputs the plurality of data representative of one or more policies, objectives, preferences or constraints related to optimization of a Plan Design.

The step of completing an analysis of the stored data may include determining, in respect of a Plan, an incremental effect of a change in a Participant Deferral formula on a number and percentage of all Participants having one or more of a Retirement Readiness Ratio within a specified range, a Secure Retirement date within a specified range of dates, a Secure Retirement Total Savings Balance within a specified dollar range, a Secure Retirement Total Savings Balance within a specified percentage range of annual earnings, a Secure Retirement Participant Deferral Rate within a specified percentage range of annual earnings and a Secure Retirement Employer Total Contribution within a specified percentage range of annual earnings. The step of completing an analysis of the stored data may include determining, in respect of a Plan, an incremental effect of a change in an Employer Total Contribution formula on a number and percentage of all Participants having one or more of a Retirement Readiness Ratio within a specified range, a Secure Retirement date within a specified range of dates, a Secure Retirement Total Savings Balance within a specified dollar range, a Secure Retirement Total Savings Balance within a specified percentage range of annual earnings, a Secure Retirement Participant Deferral rate within a specified percentage range of annual earnings and a Secure Retirement Employer Total Contribution within a specified percentage range of annual earnings.

The step of completing an analysis of the stored data may include calculating, in respect of a specified Employer Total Contribution formula, one or more of a dollar cost of Employer Total Contributions, an average dollar cost per Participant of an Employer Total Contribution, and an average Employer Total Contribution per Participant expressed as a percentage of Participant earnings. The step of completing an analysis of the stored data may also include calculating, in respect of one or more specified changes in an Employer Total Contribution formula, one or more of an incremental change in dollar cost of an Employer Total Contribution, an incremental change in average dollar cost per Participant of an Employer Total Contribution and an incremental change in average Employer Total Contribution per Participant expressed as a percentage of Participant earnings.

The step of completing an analysis of the stored data may include calculating in respect of a specified automatic Participant Deferral formula one or more of a total dollar amount of a plurality of Participant Deferrals, an average dollar amount of a plurality of Participant Deferrals, and an average of a plurality of Participant Deferral Rates. The step of completing an analysis of the stored data may also include calculating in respect of one or more specified changes in an automatic Participant Deferral formula one or more of an incremental change in total dollar amount of a plurality of Participant Deferrals, an incremental change in average dollar amount of a plurality of Participant Deferrals, and an incremental change in average of a plurality of Participant Deferral Rates.

A particular report may include a combination of text, data, and images communicating a percentage of Participants in each of a plurality of groups corresponding with different specified ranges of one or more of current age, Participant Deferral Rate, dollar value of Total Savings Balance, Total Savings Balance expressed as a percentage of current annual earnings, dollar value of total savings in a Plan, Participant Deferral Rate, dollar value of Employer Total Contribution and Employer Total Contribution expressed as a percentage of earnings rate, and Retirement Readiness Ratio.

A particular report may include a combination of text, data and images communicating, in respect of a Participant, one or more of current age, a target retirement age, life expectancy, Total Savings Balance, Plan account balance, periodic income, Participant Deferral Rate, Employer Total Contribution, percentage of Plan account balance invested in each of a plurality of asset classes and Required Retirement Income. A particular report may also include a combination of text, data and images communicating, in respect of a Participant, a projection of a percentage of Retirement Income funded by one or more of Social Security entitlements, employer-provided benefits, Participant Deferrals, Employer Total Contributions, and investment returns. A particular report may further include a combination of text, data and images communicating, in respect of a Participant, a change in a Retirement Readiness Ratio related to an incremental change in one or more of Employer Total Contribution, Participant Deferral, current Total Savings Balance and assumed investment rate of return.

A particular report may include a combination of text, data and images communicating a periodic cash flow representing one or more of Participant earnings, Participant Deferral, Employer Total Contribution, investment returns, income from Social Security, income from employer-provided benefits, Required Retirement Income, projected expenditure in retirement, Total Savings Balance and Plan savings.

A particular report may include a combination of text, data and images communicating Plan Design provisions, including one or more of eligibility to participate, use of Auto-Enrollment for newly-hired employees, use of Auto-Enrollment for employees who are not newly-hired employees, a minimum Auto-Enrollment Participant Deferral Rate, an Auto-Escalation Rate, a Maximum Automatic Participant Deferral Rate, use of Catch-up, total annual Employer Total Contribution budget, Employer Basic Contribution, Employer Matching Contribution formula, rules for determine vesting of employer-provided benefits, use of a Qualified Default Investment Alternative, policy regarding default of newly-hired employees retirement savings into a Qualified Default Investment Alternative, policy regarding default of employees who are not newly-hired employees into a Qualified Default Investment Alternative, provision of an automatic portfolio rebalancing service, provision of a professional investment advice service, provision of a brokerage account and provision of a fund window service.

A particular report may include a combination of text, data and images communicating, in respect of a Plan Design, one or more of an average dollar value of Participant Deferral for a plurality of Participants, an average value of participant deferrals for a plurality of Participants expressed as a percentage of earnings, a percentage of Participants affected by a specified change in a Plan Design, a change in Participant Deferral related to a specified change in a Plan Design, an average dollar value of Employer Total Contributions for a plurality of Participants, an average value of Employer Total Contributions for a plurality of Participants expressed as a percentage of earnings and a change in total Employer Total Contributions related to a specified change in a Plan Design.

A particular report may include a combination of text, data and images communicating, in respect of a Plan Design, one or more of a number of Participants impacted by a plurality of minimum Auto-Enrollment Participant Deferral Rates, a percentage of Participants impacted by a plurality of minimum Auto-Enrollment Participant Deferral Rates, differences in Participant Deferral Rates related to differences in a plurality of Auto-Escalation Maximum Deferral Rates, differences in Employer Total Contributions related to differences in a plurality of Employer Basic Contributions, differences in Employer Total Contributions related to differences in a plurality of Employer Matching Contribution Rates and Maximum Matched Participant Deferral Rates, a percentage of Participants having a greater percentage, a similar percentage or a lesser percentage of Plan savings invested in equities compared to a percentage for a corresponding Qualified Default Investment Alternative, a percentage of Participants having more diversification, similar diversification or less diversification among investments of Plan savings compared to a measurement of diversification for a corresponding Qualified Default Investment Alternative, a percentage of Participants having at least a specified percentage of Plan savings invested in a portfolio that is automatically rebalanced, a percentage of participants using an automatic investment portfolio rebalancing service and a percentage of Participants not using a rebalancing service.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. (canceled)

2. A computerized method for determining an optimal selection of a preferred rule set from a plurality of rule sets based on input data, the method comprising the steps of:
a) at a computer server, receiving the input data comprising a plurality of separate input data sets;
b) at the computer server, establishing, based on the input data, a target value for each of the plurality of separate input data sets;
c) at the computer server, establishing the plurality of rule sets wherein each rule set in the plurality of rule sets comprises rules that, when applied one of the input data sets, establish:
i) a rule set value,
ii) a first cost, and
iii) a second cost;
d) at the computer server, and for each of the plurality of rule sets:
i) select one of the plurality of rule sets as a selected rule set;
ii) evaluate the selected rule set for each of the plurality of separate input data sets by:
(1) computing the rule set value for each separate input data set based on the selected rule set,
(2) determining a relationship between the target value and the computed rule set value for that separate input data set,
(3) computing the first cost for each separate input data set based on the selected rule set, and
(4) computing the second cost for each separate input data set based on the selected rule set; and
iii) generate a rule set assessment based on the determined relationship, the first cost, and the second cost;
e) at the computer server, comparing the generated rule set assessments to identify the preferred rule set for the input data; and
f) at the computer server, outputting an indicator of the preferred rule set.

3. The method of claim 2, further comprising identifying limits that constrain the rule sets, wherein the limits are applied to the selected rule set before computing the rule set value, the first cost, and the second cost for each separate input data set.

4. The method of claim 3, wherein the limits identify legal limitations.

5. The method of claim 4, wherein the rule sets define retirement plans and the legal limitations comprises contribution limits to the retirement plans.

6. The method of claim 2, wherein the rule sets define retirement plans and further wherein each of the plurality of separate input data sets comprises data concerning a plan participant.

7. The method of claim 6, wherein the target value comprises a target retirement expenditure that is a first amount of money the plan participant desires to be able to spend during a specified retirement period.

8. The method of claim 7, wherein the rule set value comprises a fundable retirement expenditure that is a second amount of money the plan participant can actually afford to spend during the same specified retirement period.

9. The method of claim 8, wherein the first cost comprises an employer cost for implementing the selected retirement plan given the plurality of rules for the selected retirement plan and the plurality of plan participants defined in the input data.

10. The method of claim 9, wherein the second cost comprises a participant cost for participating in the selected retirement plan given the plurality of rules for the selected retirement plan.

11. The method of claim 10, wherein the relationship comprises a retirement security assessment comprising the relationship between the plan participant's fundable retirement expenditure determined for the selected retirement plan and the plan participant's target retirement expenditure.

12. The method of claim 11, wherein the input data includes data that defines investing and saving behavior of the plurality of plan participants.

13. The method of claim 11, wherein the target retirement expenditure reflects employment earnings, changes in cost of living, and marital status.

14. The method of claim 11, wherein the fundable retirement expenditure includes effects of contributions made by the plan participants, effects of contributions made by the employer, and effects of investing.

15. The method of claim 11, wherein the fundable retirement expenditure includes effects of taxation and effects of social security benefits.

16. The method of claim 11, wherein a first rule set that defines a first retirement plan includes a first condition that must be satisfied in order for plan participants to be eligible to participate in the first retirement plan.

17. The method of claim 11, wherein a first rule set that defines a first retirement plan includes a minimum amount by which plan participants must contribute periodically under the first retirement plan.

18. The method of claim 11, wherein a first rule set that defines a first retirement plan includes a maximum amount that plan participants are permitted to contribute under the first retirement plan.

19. The method of claim 11, wherein a first rule set that defines a first retirement plan includes an amount that the employer contributes to each of the plan participants in proportion to each plan participant's own contribution under the first retirement plan.

20. The method of claim 11, wherein a first rule set that defines a first retirement plan includes a vesting schedule.
